(19) United States
(12) Patent Application Publication
(10) Pub. No.: US 2026/0070335 A1
(43) Pub. Date: Mar. 12, 2026

(54) LIQUID EJECTION HEAD AND LIQUID EJECTION APPARATUS

(71) Applicant: CANON KABUSHIKI KAISHA, Tokyo (JP)

(72) Inventors: YOSHIYUKI NAKAGAWA, Kanagawa (JP); TAKASHI KATO, Kanagawa (JP)

(21) Appl. No.: 19/320,634

(22) Filed: Sep. 5, 2025

(30) Foreign Application Priority Data
Sep. 10, 2024 (JP) 2024-156847

(51) Int. Cl. B41J 2/14; B41J 2/045

(52) U.S. Cl. CPC B41J 2/1433; B41J 2/04563

(57) ABSTRACT

A liquid ejection head includes a first flow passage with which one end of a first individual flow passage communicates, a second flow passage with which the other end of the first individual flow passage and one end of a second individual flow passage communicate, a third flow passage with which the other end of the second individual flow passage communicates, and a plurality of first, second, and third openings provided in the first, second, and third flow passages, respectively, for allowing liquid to flow into or from each passage. When D1, D2, and D3 are defined as the sizes of the non-opening parts between two adjacent first, second, and third openings, respectively, then D2>D1 and D2>D3. The driving of the second energy generating element is controlled based on the temperature detected by the temperature sensor provided in the non-opening part between the second openings.

### BACKGROUND

### Field of the Technology

The present disclosure relates to a liquid ejection head and a liquid ejection apparatus.

### Description of the Related Art

In liquid ejection heads, circulation-type liquid ejection apparatuses are known, in which ink is circulated to discharge bubbles in the flow passage and suppress ink thickening near the ejection nozzle. As a method for circulating ink, there is a differential pressure method using a pressure difference. In the differential pressure method, by using a pressure adjustment mechanism or the like, the pressure on the inlet side that supplies ink to the ejection nozzle is made higher than the pressure on the outlet side that collects the ink, so that ink flows from the inlet side toward the outlet side. In this case, to circulate the ink, it is necessary to return the ink that has flowed to the outlet side to the inlet side, hence a pump is required as a mechanism for that purpose. Note that a pump may be provided outside the head, for example in the recording apparatus main body to circulate the liquid between a liquid ejection head and the main body, or a pump may be provided inside the liquid ejection head to circulate the liquid in the liquid ejection head. However, such a differential-pressure circulation method requires mechanisms such as a pressure adjusting mechanism and a pump, and therefore, the recording apparatus main body and the head are likely to increase in size.

Therefore, methods for circulating ink other than the differential pressure method have been studied. Specifically, in addition to a first energy generating element that generates energy for ejecting ink in an individual flow passage communicating with the ejection nozzle, a second energy generating element that generates energy for causing liquid to flow is disposed. A mechanism is known where ink circulation is achieved by driving the second energy generating element to induce flow within the individual flow passage. Japanese Patent Application Publication No. 2020-104312 discloses a configuration in which a flow passage extending in a direction crossing the ejection nozzle array, in which a plurality of ejection nozzles is arranged, is provided, and the flow passage is provided with a first energy generating element and a second energy generating element.

In a liquid ejection head equipped with a first energy generating element and a second energy generating element, there is a possibility that temperature variation may occur in the liquid ejection head due to heat generated by driving the second energy generating element to induce fluid flow.

### SUMMARY

The present disclosure is directed to suppress temperature variation in a liquid ejection head that includes a first energy generating element for ejecting liquid and a second energy generating element for causing liquid to flow in an individual flow passage communicating with the ejection nozzle.

A liquid ejection head having an ejection nozzle for ejecting liquid according to the present disclosure includes:
a first ejection nozzle array composed of a plurality of ejection nozzles arranged in a first direction;
a second ejection nozzle array composed of a plurality of ejection nozzles arranged in the first direction, the second ejection nozzle array being provided side by side with the first ejection nozzle array in a second direction intersecting the first direction;
a plurality of first individual flow passages communicating respectively with the plurality of ejection nozzles of the first ejection nozzle array, the plurality of first individual flow passages extending in the second direction;
a plurality of second individual flow passages communicating respectively with the plurality of ejection nozzles of the second ejection nozzle array, the plurality of second individual flow passages extending in the second direction;
first energy generating elements provided at positions corresponding to the ejection nozzles in the plurality of first individual flow passages and the plurality of second individual flow passages, the first energy generating elements generating energy for ejecting liquid from the ejection nozzles;
second energy generating elements provided side by side with the first energy generating elements in the second direction in the plurality of first individual flow passages and the plurality of second individual flow passages, the second energy generating elements generating energy for causing the liquid to flow;
a first flow passage provided on the opposite side to the second ejection nozzle array across the first ejection nozzle array in the second direction, the first flow passage communicating with ends on one side of the plurality of first individual flow passages;
a second flow passage provided between the first ejection nozzle array and the second ejection nozzle array in the second direction, the second flow passage communicating with ends on the other side of the plurality of first individual flow passages and ends on one side of the plurality of second individual flow passages;
a third flow passage provided on the opposite side to the first ejection nozzle array across the second ejection nozzle array in the second direction, the third flow passage communicating with ends on the other side of the plurality of second individual flow passages;
a plurality of first openings arranged in the first direction provided in the first flow passage, the first openings allowing liquid to flow into or from the first flow passage;
a plurality of second openings arranged in the first direction provided in the second flow passage, the second openings allowing liquid to flow into or from the second flow passage; and
a plurality of third openings arranged in the first direction provided in the third flow passage, the third openings allowing liquid to flow into or from the third flow passage, wherein, in a case where
D1 is a size in the first direction of a first non-opening part between two adjacent first openings,
D2 is a size in the first direction of a second non-opening part between two adjacent second openings, and
D3 is a size in the first direction of a third non-opening part between two adjacent third openings, then
D2>D1, and
D2>D3,
   and, wherein
the liquid ejection head further comprises:
a temperature sensor provided in the second non-opening part; and
a control unit for controlling driving of the second energy generating element based on the temperature detected by the temperature sensor.

Features of the present disclosure will become apparent from the following description of embodiments with reference to the attached drawings. The following description of embodiments is described by way of example.

### BRIEF DESCRIPTION OF THE DRAWINGS

FIG. 1A is a perspective view illustrating the configuration of a liquid ejection apparatus having a main ink tank provided externally to the liquid ejection head of Example 1;

FIG. 1B is a perspective view illustrating the configuration of a liquid ejection apparatus in which an ink tank is provided in the liquid ejection head;

FIG. 2A is an exploded perspective view illustrating the liquid ejection head of Example 1;

FIG. 2B is a diagram illustrating a configuration in which ejection nozzle arrays for four ink colors are arranged on one liquid ejection chip, and one liquid ejection chip can eject four colors of ink;

FIG. 2C is a diagram illustrating a configuration in which ejection nozzles for two colors of ink are provided on one liquid ejection chip, and two liquid ejection chips can eject four colors of ink;

FIG. 2D is a diagram illustrating a configuration in which ejection nozzles for one color of ink are provided on one liquid ejection chip, and four liquid ejection chips can eject four colors of ink;

FIG. 3A is a diagram illustrating the configuration near the ejection nozzle of the liquid ejection head in the straight-type ink circulation configuration of Example 1, illustrating the main components when the liquid ejection head is viewed in the Z direction;

FIG. 3B is a cross-sectional view taken along line AA of FIG. 3A;

FIG. 3C is a cross-sectional view taken along line AA of a liquid ejection head having a configuration different from that of FIG. 3B;

FIG. 3D is a cross-sectional view taken along line AA of FIG. 3A, illustrating the flow of ink when ink is ejected from the ejection nozzle;

FIG. 4A is a diagram illustrating the generation of bubbles by driving the second energy generating element (circulation heater) in the straight-type ink circulation configuration of Example 1;

FIG. 4B is a diagram illustrating the flow of ink during the contraction process of bubbles in the straight-type ink circulation configuration of Example 1;

FIG. 4C is a diagram illustrating the flow of ink after bubble elimination in the straight-type ink circulation configuration of Example 1;

FIG. 5A is a diagram illustrating the state when the recording operation by the liquid ejection apparatus is temporarily paused in the straight-type ink circulation configuration of Example 1;

FIG. 5B is a diagram illustrating the state immediately after a circulating flow is generated by the second energy generating element following FIG. 5A in the straight-type ink circulation configuration of Example 1;

FIG. 5C is a diagram illustrating the state when the recording operation is temporarily paused again following FIG. 5B in the straight-type ink circulation configuration of Example 1;

FIG. 5D is a diagram illustrating the state immediately after a circulating flow is generated again by the second energy generating element following FIG. 5C in the straight-type ink circulation configuration of Example 1;

FIG. 6A is a diagram illustrating the state when the recording operation by the liquid ejection apparatus is temporarily paused in the U-shaped ink circulation configuration of the comparative example;

FIG. 6B is a diagram illustrating the state immediately after a circulating flow is generated by the second energy generating element following FIG. 6A in the U-shaped ink circulation configuration of the comparative example;

FIG. 6C is a diagram illustrating the state when the recording operation is temporarily paused again following FIG. 6B in the U-shaped ink circulation configuration of the comparative example;

FIG. 6D is a diagram illustrating the state immediately after a circulating flow is generated again by the second energy generating element following FIG. 6C in the U-shaped ink circulation configuration of the comparative example;

FIG. 7A is a diagram illustrating the configuration near the ejection nozzle of the liquid ejection head in the U-shaped ink circulation configuration of the comparative example, illustrating the main components when the liquid ejection head is viewed in the Z direction;

FIG. 7B is a cross-sectional view taken along line AA of FIG. 7A in the U-shaped ink circulation configuration of the comparative example;

FIG. 7C is a diagram illustrating the vicinity of the individual flow passage in FIG. 7A in the U-shaped ink circulation configuration of the comparative example;

FIG. 8 is a diagram illustrating the control configuration of the liquid ejection apparatus of Example 1;

FIG. 9A is a diagram illustrating the configuration near the ejection nozzle of the liquid ejection head of Example 1, illustrating the main components when the liquid ejection head is viewed in the Z direction;

FIG. 9B is a cross-sectional view taken along line AA of FIG. 9A;

FIG. 9C is a cross-sectional view taken along line AA of FIG. 9A, and is a cross-sectional view of a liquid ejection head having a configuration different from that of FIG. 9B;

FIG. 10A is a diagram illustrating the configuration near the ejection nozzle of the liquid ejection head of Example 2, illustrating the main components when the liquid ejection head is viewed in the Z direction;

FIG. 10B is a cross-sectional view taken along line AA of FIG. 10A; and

FIG. 11 is a block diagram illustrating the control configuration of the liquid ejection apparatus of Example 1.

### DESCRIPTION OF THE EMBODIMENTS

In the following, preferred embodiments of the present disclosure will be described in detail with reference to the accompanying drawings. Note that the following embodiments do not limit the subject matter of the present disclosure, and the combinations of features described in the embodiments are not necessarily all essential to the solution according to the present disclosure. The same reference numerals denote the same components. In the description below, a basic configuration according to the present disclosure is first explained, followed by explanation of characteristic components according to the present disclosure.

### Example 1

The liquid ejection apparatus 50 of Example 1 of the present disclosure will be described. The liquid ejection apparatus 50 is an inkjet recording apparatus that uses an inkjet recording method, and includes a liquid ejection head 1 capable of ejecting ink as a liquid.

### Liquid Ejection Apparatus

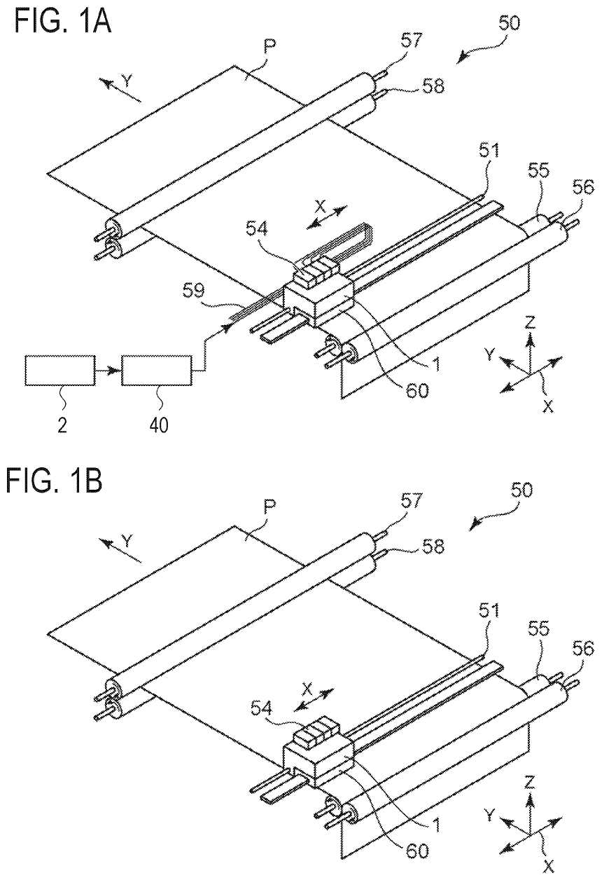

FIGS. 1A and 1B are perspective views illustrating the configuration of the liquid ejection apparatus 50 of Example 1. The liquid ejection apparatus 50 illustrated in FIGS. 1A and 1B is a liquid ejection apparatus (serial-type liquid ejection apparatus) that records images by ejecting liquid onto a recording medium P with a liquid ejection head 1 that scans in a direction intersecting the conveyance direction of the recording medium P. The present disclosure is not limited to serial-type liquid ejection apparatuses, but is also applicable to page-wide liquid ejection apparatuses that record images by ejecting liquid onto a recording medium conveyed in the conveyance direction using a line head (page-wide type head) that is long in the page width direction of the recording medium. Note that the liquid ejection head 1 of Example 1 can eject four types of ink: black (K), cyan (C), magenta (M), and yellow (Y), enabling full-color images with these inks. The ink that can be ejected from the liquid ejection head 1 is not limited to the above four types of ink. The present disclosure is also applicable to liquid ejection heads capable of ejecting other types of ink, and the type and number of inks ejected from the liquid ejection head are not limited.

In the liquid ejection apparatus 50, the liquid ejection head 1 is mounted on a carriage 60. The carriage 60 reciprocates along a main scanning direction (X direction) on a guide shaft 51. The recording medium P is conveyed in a sub-scanning direction (Y direction) intersecting the main scanning direction by conveyance rollers 55, 56, 57, and 58, which serve as conveyance members. In Example 1, the main scanning direction and the sub-scanning direction are orthogonal. In each of the figures referred to below, the Z direction indicates the vertical direction and intersects the X-Y plane defined by the X and Y directions. In Example 1, the Z direction is orthogonal to the X-Y plane.

FIG. 1A illustrates a configuration in which a main ink tank 2, functioning as a liquid storage portion, is provided outside the liquid ejection head 1. The ink stored in the main ink tank 2 is supplied to a sub-ink tank 54 on the liquid ejection head 1 side via an ink supply tube 59 or the like, driven by the external pump 40. On the other hand, FIG. 1B illustrates a configuration in which there is no main ink tank 2 outside the liquid ejection head 1, and the liquid ejection head 1 is provided with an ink tank 54. In this configuration, the liquid ejection head 1 is integrally formed with the ink tank 54 and can be configured to be attachable/detachable with respect to the carriage 60. Alternatively, the liquid ejection head 1 may be integrally formed with the carriage 60, and only the ink tank 54 may be configured to be attachable/detachable. The external pump 40 that supplies ink to the ink tank 54 is a supply unit for supplying ink to the liquid ejection head 1. Example 1 will be described referring to the configuration of FIG. 1A as an example.

The liquid ejection head 1 includes individual ejection units, described later. While the detailed configuration will be explained subsequently, each individual ejection unit is a recording element unit including an ejection nozzle for ejecting liquid and an individual flow passage communicating with the ejection nozzle. A pressure chamber is formed at a position in the individual flow passage corresponding to the ejection nozzle, in which a first energy generating element (ejection energy generating element) that generates energy to eject liquid from the ejection nozzle is provided. At a different position within the individual flow passage from the first energy generating element, a second energy generating element (flow energy generating element) that generates energy to cause liquid to flow is provided. The liquid ejection head 1 has a plurality of individual ejection units, each supplied with liquid via a supply flow passage communicating with the individual flow passage.

Evaporation of volatile components such as moisture from the liquid at the ejection nozzle of the liquid ejection head 1, and the consequent concentration of solids near the ejection nozzle, may cause unstable liquid ejection. Various measures are employed to prevent this. For example, the liquid ejection apparatus 50 may be equipped with a cap member (not illustrated) that can cover the ejection nozzle surface of the liquid ejection head 1, positioned offset in the X direction from the conveyance passage of the recording medium P. The cap member covers the ejection nozzle surface of the liquid ejection head 1 when recording is not performed, serving to prevent drying and protect the ejection nozzles.

Furthermore, an ink suction mechanism (not illustrated) may be provided. When an ink suction mechanism is provided, the cap member is used for ink suction operations from the ejection nozzle, etc. This suction operation refreshes the ink near the ejection nozzle and helps maintain image quality.

Additionally, so-called preliminary ejection (pre-ejection) may be performed during non-recording periods to discard concentrated ink. Preliminary ejection (on-paper preliminary ejection/in-page preliminary ejection) may also be performed at inconspicuous positions and amounts on the recording medium during recording operation. While these methods significantly improve image quality, they discard some ink to refresh the ejection nozzle, so reducing waste ink amount is desirable.

To address these issues, a second energy generating element (flow energy generating element) is provided in the individual flow passage to circulate ink within the flow passage. This suppresses drying of the ejection nozzle and ink concentration near the ejection nozzle while reducing waste ink. Specifically, it reduces the frequency of preliminary ejection and suction recovery. Furthermore, by reducing the number of times preliminary ejection and the like are performed, throughput and yield can be improved.

The second energy generating element does not necessarily need to be provided in all the individual ejection units of the liquid ejection head. If it is provided in some of the individual ejection units, the above effects can be obtained compared to when it is not provided.

Further, the liquid ejection head 1 may be configured such that all locations corresponding to the four types of ink are provided with the second energy generating element, or only locations corresponding to one type of ink are provided with the second energy generating element. The liquid ejection head 1 may be configured to circulate at least one type of ink, rather than all four types.

### Liquid Ejection Head

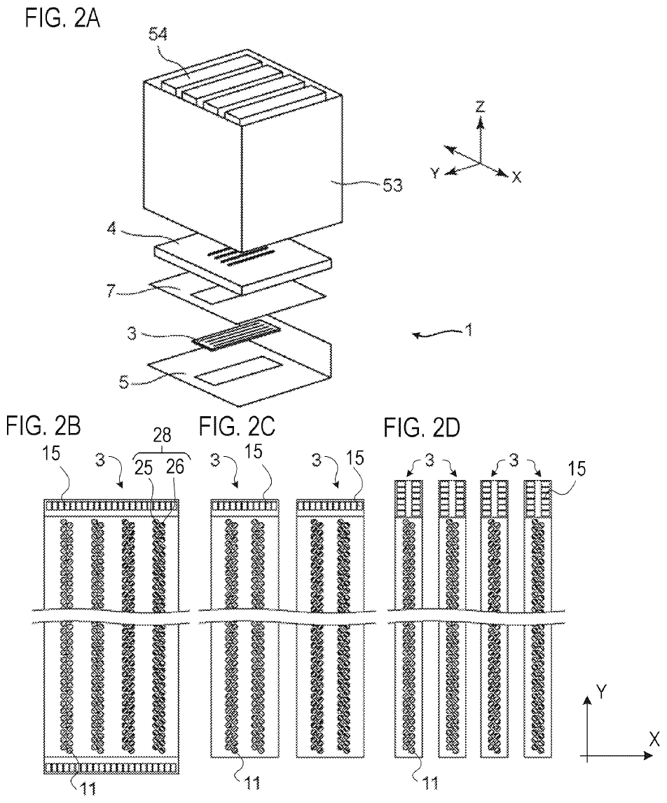

The configuration of the liquid ejection head 1 of Example 1 will be described. FIGS. 2A to 2D are diagrams illustrating the configuration of the liquid ejection head 1 of Example 1. FIG. 2A is an exploded perspective view of the liquid ejection head 1.

The liquid ejection head 1 includes four sub-ink tanks 54 that temporarily store ink, and a liquid ejection chip 3 that ejects ink supplied from the sub-ink tanks 54 onto the recording medium P.

The liquid ejection head 1 further includes a first support member 4, a second support member 7, and an electrical wiring member 5 (electrical wiring tape). The liquid ejection chip 3 is connected to one surface of the first support member 4, and the ink tank 54 is connected to the other surface. The first support member 4 has a flow passage penetrating from the one surface to the other surface, supporting the liquid ejection chip 3 while transferring ink supplied from the sub-ink tank 54 to the liquid ejection chip 3.

The second support member 7 is connected to the first support member 4 on the surface where the liquid ejection chip 3 is connected. The second support member 7 has an opening through which the liquid ejection chip 3 can be inserted; it is connected to the first support member 4 such that the liquid ejection chip 3 is positioned within this opening. The second support member 7 also supports the electrical wiring member 5.

The electrical wiring member 5 is electrically connected to the liquid ejection chip 3 and transmits ejection signals, received from the main body of the liquid ejection apparatus 50 or the like, to the liquid ejection chip 3 for ink ejection.

In Example 1, the liquid ejection head 1 is securely mounted on the carriage 60 by an alignment unit and electrical contacts (not illustrated) provided on the carriage 60 of the liquid ejection apparatus 50. The liquid ejection head 1 moves with the carriage 60 in the main scanning direction (X direction) while ejecting ink, thus performing recording on the recording medium P.

An ink supply tube 59 is provided on the external pump 40 connected to the main ink tank 2, which acts as the ink supply source (see FIG. 1A). A liquid connector (not illustrated) is attached at the tip of the ink supply tube 59. When the liquid ejection head 1 is mounted on the liquid ejection apparatus 50, this liquid connector provided at the tip of the ink supply tube 59 is sealingly engaged with the liquid connector insertion port, which is a liquid inlet provided on the housing of the liquid ejection head 1. Consequently, an ink supply passage is formed from the ink tank 2 to the liquid ejection head 1 via the external pump 40. In Example 1, since four types of ink are used, four sets of ink tanks 2, external pumps 40, ink supply tubes 59, and sub-ink tanks 54 are provided, each corresponding to one ink. Four ink supply passages corresponding to the inks are independently formed.

As described above, the liquid ejection apparatus 50 includes an ink supply system where ink is supplied from an ink tank 2 located outside the liquid ejection head 1. Note that the liquid ejection apparatus 50 does not include an ink collection system that collects ink from inside the liquid ejection head 1 back to the ink tank 2. Accordingly, the liquid ejection head 1 has a liquid connector insertion port to connect the ink supply tube 59 from the ink tank 2, but does not have a connector insertion port for connecting a tube that collects ink from the liquid ejection head 1 back to the ink tank 2. The liquid connector insertion port is provided individually for each ink.

FIGS. 2B, 2C, and 2D illustrate example configurations of the liquid ejection chip 3 constituting the liquid ejection head 1. Each chip 3 is equipped with an ejection nozzle 11 and pads 15 for electrical mounting. FIG. 2A depicts the chip configuration illustrated in FIG. 2B.

The liquid ejection head 1 is capable of ejecting four colors of ink, for example, black, cyan, magenta, and yellow. On the liquid ejection chip 3, ejection nozzle arrays 28 are formed for each ink color. Each ejection nozzle array 28 includes a first row 25 and a second row 26, each consisting of a plurality of ejection nozzles 11 arranged at equal intervals in the Y direction (first direction). The first row 25 and the second row 26 are arranged side by side in the X direction (second direction). The ejection nozzles 11 in the first row 25 and those in the second row 26 are offset from each other in the Y direction. Although the illustrated example illustrates an ejection nozzle array 28 consisting of two rows of a plurality of ejection nozzles 11, the ejection nozzle array 28 may also consist of a single row of a plurality of ejection nozzles 11.

FIG. 2B illustrates a configuration where a single liquid ejection chip 3 includes ejection nozzle arrays 28 for four ink colors, enabling one liquid ejection chip 3 to eject all four colors. Note that a configuration may be used in which only the black ink has two ejection nozzle arrays 28, resulting in a total of five rows of the ejection nozzle arrays 28 for the four colors.

FIG. 2C illustrates a configuration where one liquid ejection chip 3 has ejection nozzles for two ink colors, and two such chips 3 together can eject four colors. As a configuration for mounting two liquid ejection chips 3, two liquid ejection chips 3 may be mounted on one liquid ejection head 1, or two liquid ejection heads 1 each mounted with one liquid ejection chip 3 may be provided.

FIG. 2D illustrates a configuration where each liquid ejection chip 3 has an ejection nozzle for one ink color, and four such liquid ejection chips 3 can eject four colors. As a configuration for mounting four liquid ejection chips 3, four liquid ejection chips 3 may be mounted on one liquid ejection head 1, or four liquid ejection heads 1 each mounted with one liquid ejection chip 3 may be provided.

Further, as shown in FIGS. 2C and 2D, when the liquid ejection chips 3 are divided into multiple units, they do not all need to have the same chip length. Various other combinations of colors per chip are possible, and the total number of colors may be more than four as well.

### Straight-Type Ink Circulation Configuration

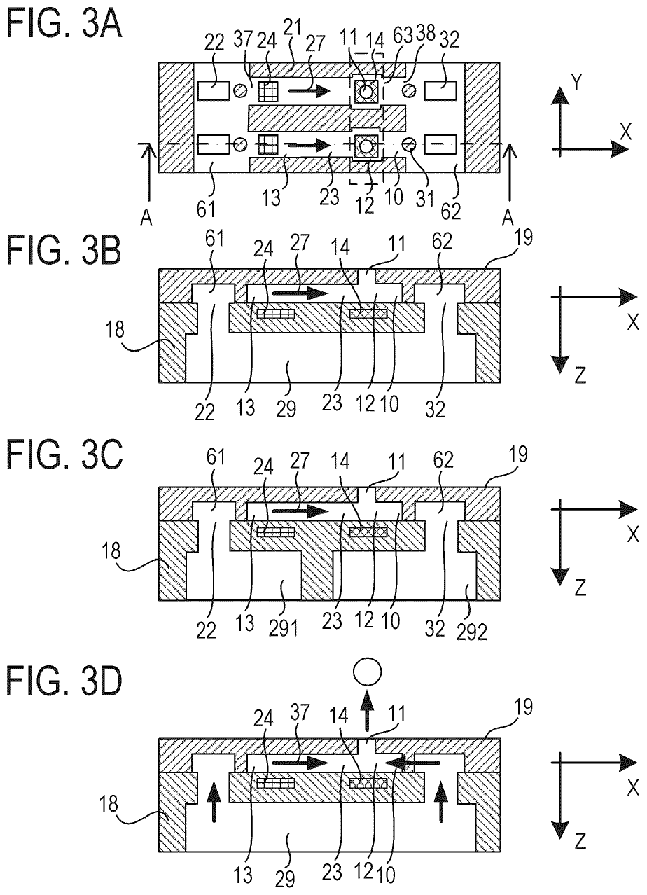

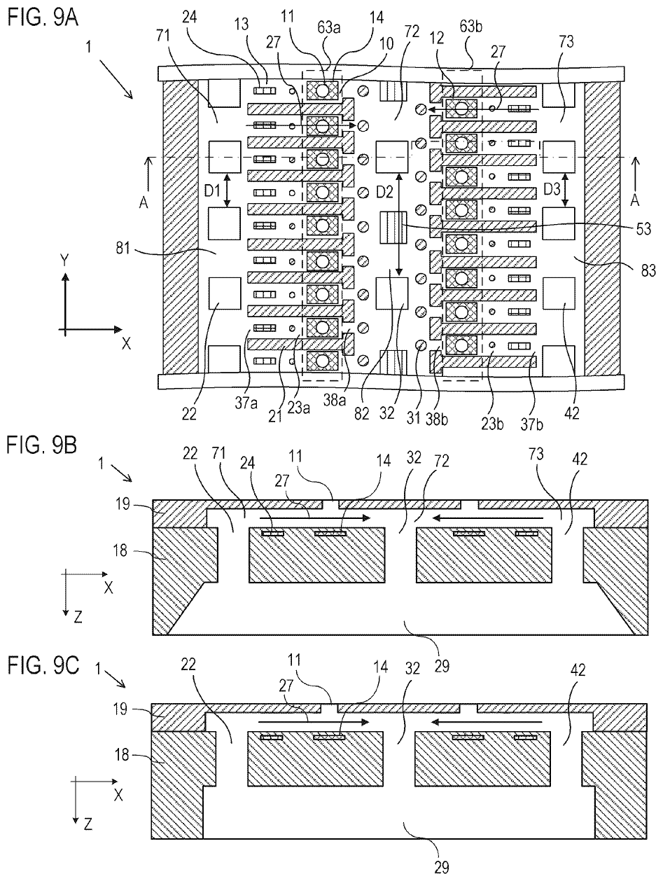

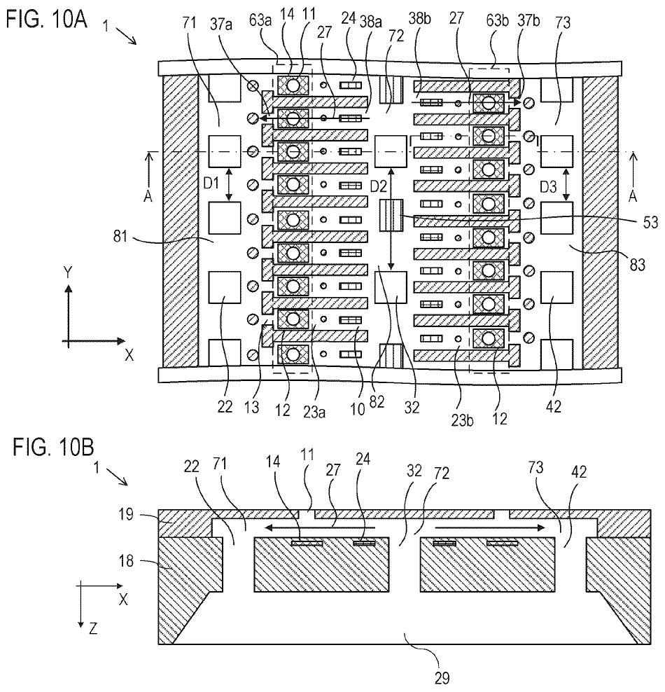

FIGS. 3A to 3D to FIGS. 5A to 5D are diagrams illustrating the straight-type ink circulation configuration of Example 1. FIGS. 3A to 3D to FIGS. 5A to 5D are schematic diagrams illustrating the mechanism of generation of circulating flow and its effects in the straight-type ink circulation configuration. Therefore, the configuration of the liquid ejection head 1 illustrated in FIGS. 3A to 3D to FIGS. 5A to 5D is partially different from the configuration of the liquid ejection head 1 of Example 1 (which will be described later using FIGS. 9A to 9C and FIGS. 10A and 10B). However, the mechanism of generation of ink circulation and its effects described with reference to FIGS. 3A to 3D to FIGS. 5A to 5D are the same in the liquid ejection head 1 of Example 1. In addition, among the following explanations with reference to FIGS. 3A to 3D to FIGS. 5A to 5D, unless otherwise specified, the content applicable to the liquid ejection head 1 of Example 1 is incorporated as the description of Example 1.

FIG. 3A is a diagram illustrating the configuration near the ejection nozzle 11 of the liquid ejection head 1, illustrating the main components when the liquid ejection head 1 is viewed in the Z direction. FIG. 3B is a cross-sectional view taken along line AA of FIG. 3A. FIG. 3C is a cross-sectional view taken along line AA of FIG. 3A, and is a cross-sectional view of a liquid ejection head 1 having a configuration different from that of FIG. 3B. FIG. 3D is a cross-sectional view taken along line AA of FIG. 3A, illustrating the flow of ink when ink is ejected from the ejection nozzle.

The liquid ejection head 1 has a laminated substrate 18 and an orifice plate 19, and the orifice plate 19 is formed with an ejection nozzle array 63 composed of a plurality of ejection nozzles 11 arranged in the first direction (Y direction). A meniscus of ink is formed at the ejection nozzle 11, and an ejection nozzle interface as the interface between the ink and the atmosphere is formed.

Between the substrate 18 and the orifice plate 19, a plurality of individual flow passages 23 is formed, each of which is partitioned by partition walls 21, communicates with each of the ejection nozzles 11, and extends in the second direction (X direction). The individual flow passages 23 extend linearly in the second direction (X direction) intersecting the first direction (Y direction) in which the plurality of ejection nozzles 11 is arranged in the ejection nozzle array 63. In the example of FIGS. 3A to 3D, the second direction is orthogonal to the first direction.

Further, a first flow passage 61 communicating with one end of the individual flow passages 23 and a second flow passage 62 communicating with the other end of the individual flow passages 23 are formed. The first flow passage 61 and the second flow passage 62 each extend in the Y direction and are located on opposite sides in the X direction across the ejection nozzle array 63.

In the individual flow passage 23, a pressure chamber 12 is formed at a position corresponding to the ejection nozzle 11. The pressure chamber 12 communicates with the first flow passage 61 via a connecting flow passage 13 and with the second flow passage 62 via a connecting flow passage 10. That is, the individual flow passage 23 includes the pressure chamber 12, connecting flow passage 10, and connecting flow passage 13.

On the substrate 18, a first energy generating element 14 (ejection energy generating element) for generating energy to eject ink in the pressure chamber 12 is provided at a position corresponding to the ejection nozzle 11. Here, an electrothermal transducer is used as the first energy generating element 14. By driving and heating the first energy generating element 14, ink in the pressure chamber 12 is vaporized, and the vaporization energy causes ink to be ejected from the ejection nozzle 11. Note that the first energy generating element 14 is not limited to an electrothermal transducer and may use a piezoelectric element or the like.

Further, on the substrate 18, a second energy generating element 24 (flow energy generating element) for generating energy to produce a circulating flow 27 (flow) indicated by the arrow in the ink in the individual flow passage 23 is provided. Here, an electrothermal transducer is used as the second energy generating element 24. The second energy generating element 24 is provided at a position in the X direction different from the first energy generating element 14.

In the first flow passage 61, a plurality of first openings 22, through which ink flows in or out between the common flow passage 29, is arranged in the Y direction. In the second flow passage 62, a plurality of second openings 32, through which ink flows in or out between the common flow passage 29, is arranged in the Y direction. The first openings 22 and the second openings 32 each penetrate the substrate 18 in the stacking direction.

The first energy generating element 14, the ejection nozzle 11, and the pressure chamber 12 are located closer to the second opening 32 than to the first opening 22. The second energy generating element 24 is located closer to the first opening 22 than to the second opening 32. The individual flow passage 23 communicates with the first opening 22 at one end in the X direction (−X direction side) and communicates with the second opening 32 at the other end (+X direction side). The connecting flow passage 13 is located on the side of the second energy generating element 24 in the X direction relative to the ejection nozzle array 63. The two ends of the individual flow passage 23 in the X direction are located on opposite sides with respect to the ejection nozzle array 63.

There are mainly two types of ink flow in the individual flow passage 23. That is, (1) a first ink flow for refilling after ink ejection by driving the first energy generating element 14, and (2) a second ink flow, which is the circulating flow 27 generated by driving the second energy generating element 24.

When the first energy generating element 14 is driven and ink is ejected from the ejection nozzle 11, as illustrated in FIG. 3D, a flow 27 occurs in which ink flows into the pressure chamber 12 of the individual flow passage 23 from both the first opening 22 and the second opening 32. As a result, ink is supplied to the individual flow passage 23 from both the first opening 22 and the second opening 32.

When the second energy generating element 24 is driven to form the circulating flow 27, ink flows into the individual flow passage 23 from the inflow port 37 on the connecting flow passage 13 side (first opening 22 side), and ink flows out from the outflow port 38 on the connecting flow passage 10 side (second opening 32 side). The ink that flows out from the second opening 32 returns to the first opening 22 via the common flow passage 29. As a result, a circulating flow 27 indicated by the arrows is generated in the individual flow passage 23.

In the configuration illustrated in FIG. 3B, the first opening 22 and the second opening 32 are connected to the common flow passage 29 within the chip of the liquid ejection head 1. In the configuration illustrated in FIG. 3C, the first opening 22 and the second opening 32 are connected to independent flow passages 291 and 292 within the chip of the liquid ejection head 1, and are connected to the common flow passage outside the chip of the liquid ejection head 1. The present disclosure can be applied to either configuration.

A filter for removing foreign matter in the ink can be provided in the ink circulation flow passage inside and outside the liquid ejection head 1. In the example illustrated in FIGS. 3A to 3D, the filter 31 is provided near the end on the one end side in the X direction (the side of the second energy generating element 24) and near the end on the other end side (the side of the first energy generating element 14) of the individual flow passage 23. Note that a filter may be disposed between the first energy generating element 14 and the second energy generating element 24 in the individual flow passage 23. In this case, a filter need not be disposed near the end on the one end side (the side of the second energy generating element 24) of the individual flow passage 23 in the X direction.

In the liquid ejection head 1, the first energy generating element 14 and the second energy generating element 24 are arranged side by side in the X direction in the individual flow passage 23 that extends linearly in the X direction. By driving the second energy generating element 24, a circulating flow 27 of ink can be generated in the individual flow passage 23. The two ends of the individual flow passage 23 are located on opposite sides in the X direction across the ejection nozzle array 63. Therefore, the inflow port 37 (upstream end) and the outflow port 38 (downstream end) of the circulating flow 27 are respectively connected to different first flow passage 61 and second flow passage 62 and arc separated from each other. Such an ink circulation configuration is referred to as a straight-type ink circulation configuration.

### Process of Circulating Flow Generation

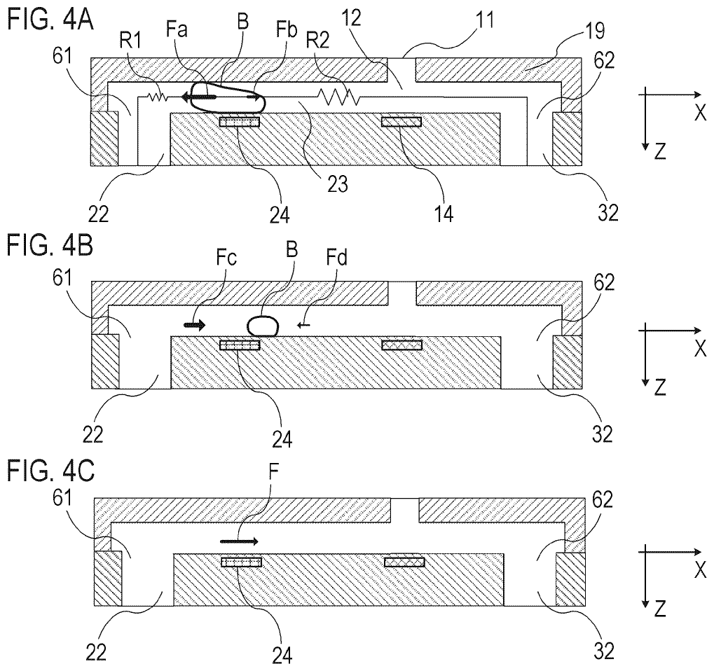

FIGS. 4A to 4C are diagrams illustrating the process of generating an ink circulating flow by driving the second energy generating element 24. FIGS. 4A, 4B, and 4C are cross-sectional views similar to FIG. 3B, and illustrate the process in which ink is heated by the second energy generating element 24, and a bubble is generated, grows, contracts, and disappears due to film boiling of the ink.

FIG. 4A is a diagram illustrating the generation of a bubble B by driving the second energy generating element 24 (circulation heater). The second energy generating element 24 is located closer to the first opening 22 than to the second opening 32. Therefore, the flow resistance R1 between the second energy generating element 24 and the first opening 22 is smaller than the flow resistance R2 between the second energy generating element 24 and the second opening 32. FIG. 4A illustrates an equivalent circuit in which such flow resistances R1 and R2 are represented analogously to electrical resistance. The bubble B generated by film boiling of the ink grows biased toward the first flow passage 61 side with the smaller flow resistance R1, as illustrated in FIG. 4A, due to the difference in flow resistance R1 and R2. Accordingly, in the individual flow passage 23, the ink flow Fa toward the first flow passage 61 becomes larger than the ink flow Fb toward the second flow passage 62.

FIG. 4B is a diagram illustrating the ink flow during the contraction process of the bubble B. During the contraction process of the bubble B, ink flows in to compensate for the contracted volume. At this time, as illustrated in FIG. 4B, the ink flow Fc flowing in from the first opening 22 side with the smaller flow resistance R1 is greater than the ink flow Fd flowing in from the second opening 32 side with the larger flow resistance R2. In addition, the position where the bubble B disappears shifts from above the second energy generating element 24 toward the second opening 32.

FIG. 4C is a diagram illustrating the ink flow after the bubble B disappears. Due to the relationship Fc>Fd generated in FIG. 4B, a circulating flow F of ink is generated from the first opening 22 toward the second opening 32.

The magnitude of such circulating flow F is affected by the ratio of flow resistances R1 and R2 and the size of the bubble B. For example, when using an electrothermal transducer (heater) as the second energy generating element 24, the second energy generating element 24 may be located closer to one end of the individual flow passage 23 than the first energy generating element 14. More specifically, the flow resistance ratio R1/R2 may be set in the range of 0.05 to 0.40. By setting the flow resistance ratio R1/R2 in this range, the circulating flow F can be maximized.

By increasing the ink flow Fa toward the first flow passage 61 illustrated in FIGS. 4A and 4B, and increasing the ink flow Fc flowing in from the first opening 22, the circulating flow F can be increased. Therefore, it is effective to reduce the flow resistance R1. In addition, by decreasing the ink flow Fb toward the second flow passage 62 and decreasing the ink flow Fd flowing in from the second opening 32, the circulating flow F can be increased. Therefore, it is effective to increase the flow resistance R2. From the above, by reducing the flow resistance R1 and increasing the flow resistance R2, that is, by reducing the flow resistance ratio R1/R2, the circulating flow F can be increased.

Further, as the accumulation of bubbles B increases, the volume of ink expelled from the individual flow passage 23 by bubbling increases, so the circulating flow F becomes larger. Methods for increasing the volume of bubble B include increasing the size of the second energy generating element 24, widening or increasing the height of the connecting flow passage 13 to reduce the flow resistance R1, lowering the ink viscosity, increasing the temperature of the liquid ejection head 1, and using double pulses for the drive pulse, among others.

When part of the ink circulating flow F enters the ejection nozzle 11, the concentrated ink in the ejection nozzle 11 is sent toward the second opening 32 side, and fresh ink flows into the ejection nozzle 11 from the first opening 22 side through the connecting flow passage 13. This suppresses the retention of concentrated ink in the ejection nozzle 11, reduces the influence of concentrated ink, and allows the initial ink ejection state to be maintained.

The circulating flow F is a transient flow that occurs during the growth and contraction process of the generated bubble B. Therefore, after the bubble B disappears, the inertial flow attenuates over time and stops after a certain period. By repeatedly driving the second energy generating element 24, the circulating flow F can be generated continuously for a certain period. The drive frequency of the second energy generating element 24 only needs to be such that concentrated ink in the ejection nozzle 11 can be discharged, and is not particularly limited. However, since the time from bubble B generation to disappearance is about 10 μs, driving at a high frequency such as 100 kHz reduces the effect. Therefore, for example, the second energy generating element 24 may be driven at a frequency of about 100 Hz to several tens of kHz.

If the drive frequency is high, the circulating flow F is maintained, so the effect of discharging concentrated ink is greater. On the other hand, it is useful to consider the temperature rise of the ink due to heat generation associated with driving the second energy generating element 24. Therefore, the number of times the second energy generating element 24 is driven may be appropriately controlled.

### U-Shaped Ink Circulation Configuration

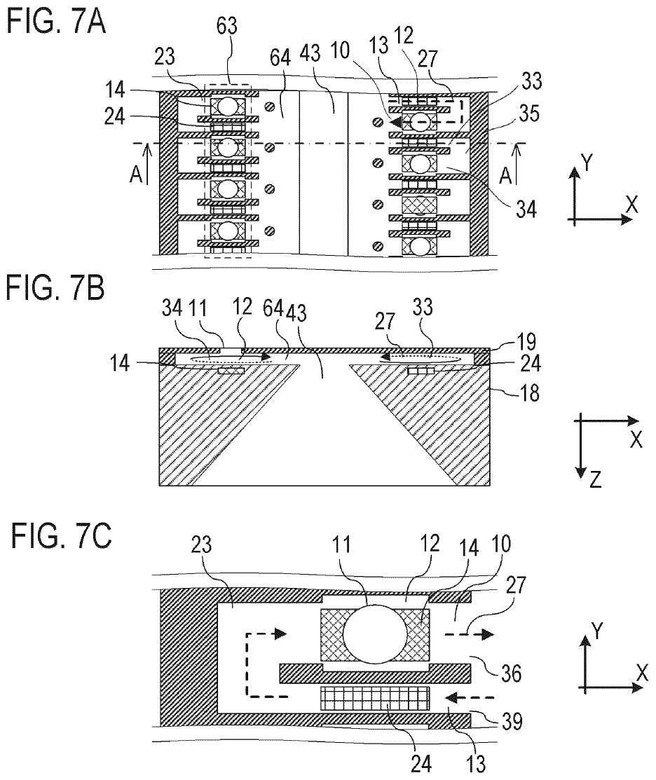

As a comparative example to the straight-type ink circulation configuration, a U-shaped ink circulation configuration will be described. FIGS. 7A to 7C illustrate the liquid ejection head of the comparative example. FIG. 7A is a diagram illustrating the configuration near the ejection nozzle 11 of the liquid ejection head of the comparative example, and illustrates the main components when the liquid ejection head 1 is viewed in the Z direction. FIG. 7B is a cross-sectional view taken along line AA in FIG. 7A. FIG. 7C is a diagram illustrating the vicinity of the individual flow passage in FIG. 7A.

The liquid ejection head of the comparative example has a laminated substrate 18 and an orifice plate 19, and the orifice plate 19 is formed with an ejection nozzle array 63 composed of a plurality of ejection nozzles 11 arranged in the first direction (Y direction). In parallel with the ejection nozzle array 63, the first energy generating element 14 and the second energy generating element 24 are alternately arranged.

Between the substrate 18 and the orifice plate 19, a plurality of individual flow passages 23, each partitioned by partition walls 21, each communicating with each of the ejection nozzles 11, is formed in a U-shape. The individual flow passage 23 has a first part 33 and a second part 34 extending in the X direction, and a third part 35 extending in the Y direction that connects one end in the X direction of the first part 33 and the second part 34. The other end in the X direction of the first part 33 and the second part 34 communicates with a flow passage 64, and the flow passage 64 communicates with a common flow passage 43. The two ends of the individual flow passage 23 are adjacent in the Y direction and communicate with the flow passage 64 on the same side (one side) in the X direction. The common flow passage 43 is provided so as to penetrate the substrate 18.

The first part 33 is provided with the second energy generating element 24, and the second part 34 is provided with the pressure chamber 12 and the first energy generating element 14. The individual flow passage 23 is a flow passage formed in a U-shape so as to connect the first energy generating element 14 and the second energy generating element 24, which are arranged in the Y direction.

In the individual flow passage 23, a pressure chamber 12 is formed at a position corresponding to the ejection nozzle 11. The pressure chamber 12 communicates with the flow passage 64 via the connecting flow passage 10 and also communicates with the flow passage 64 via the connecting flow passage 13. That is, the individual flow passage 23 includes the pressure chamber 12, connecting flow passage 10, and connecting flow passage 13. The connecting flow passage 13 is formed in a part of the first part 33, the third part 35, and a part of the second part 34, and the connecting flow passage 10 is formed in a part of the second part 34. The first energy generating element 14 is located near the connecting portion between the connecting flow passage 10 and the flow passage 64, and the second energy generating element 24 is located near the connecting portion between the connecting flow passage 13 and the flow passage 64.

There are two types of ink flow in the individual flow passage 23: (1) a first ink flow for refilling after ink ejection by driving the first energy generating element 14, and (2) a second ink flow, which is the circulating flow 27 generated by driving the second energy generating element 24.

When the first energy generating element 14 is driven and ink is ejected from the ejection nozzle 11, ink is supplied from the common flow passage 43 for ejection, and ink flows into the pressure chamber 12 from both the connecting flow passage 10 side and the connecting flow passage 13 side.

When the second energy generating element 24 is driven to form the circulating flow 27, ink flows into the individual flow passage 23 from the inflow port 39 on the connecting flow passage 13 side and flows out from the outflow port 36 on the connecting flow passage 10 side. Due to the circulating flow 27 indicated by the arrows generated in the individual flow passage 23, ink flows in and out of the common flow passage 43. Note that a configuration may be adopted in which a plurality of openings arranged in the Y direction is provided in the flow passage 64 to communicate with a common flow passage (not illustrated), as illustrated in FIGS. 3A to 3D. In this case, the plurality of openings communicates with the common flow passage within the chip as in FIG. 3B.

In the liquid ejection head of the comparative example, the first energy generating element 14 and the second energy generating element 24 are arranged side by side in the Y direction along the ejection nozzle array 63 in the U-shaped individual flow passage 23. By driving the second energy generating element 24, a circulating flow 27 of ink can be generated in the individual flow passage 23. The two ends of the individual flow passage 23 are located on the same side (one side) in the X direction with respect to the ejection nozzle array 63. Therefore, the inflow port 39 (upstream end) and the outflow port 36 (downstream end) of the circulating flow 27 are connected to the same flow passage 64. Such an ink circulation configuration is referred to as a U-shape.

### Re-Circulation Concentration

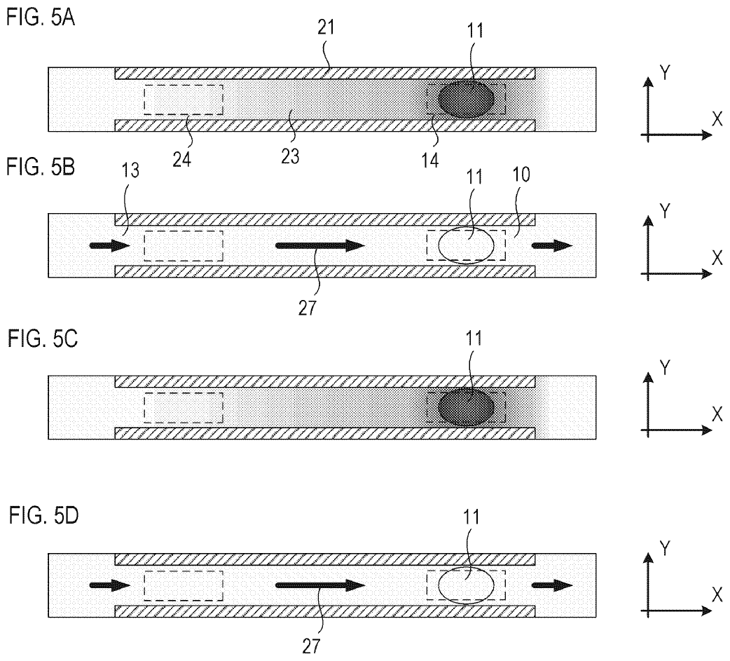

FIGS. 5A to 5D are diagrams illustrating the circulating flow and concentration of ink in the straight-type ink circulation configuration. In FIGS. 5A to 5D, the degree of ink concentration is represented by shading, and the darker areas indicate a higher concentration level.

FIG. 5A illustrates the state when the recording operation by the liquid ejection apparatus 50 is temporarily paused. When the recording operation is temporarily paused, the volatile components of the ink evaporate from the ejection nozzle 11, and the concentration of ink near the ejection nozzle 11 increases.

FIG. 5B illustrates the state immediately after the circulating flow 27 is generated by the second energy generating element 24. The concentration near the ejection nozzle 11 is eliminated by the circulating flow 27. The concentrated ink near the ejection nozzle 11 is discharged from the outflow port 38, fresh ink flows in from the inflow port 37, and the concentration is eliminated throughout the individual flow passage 23.

FIG. 5C illustrates the state when the recording operation is temporarily paused again. As in the state of FIG. 5A, the concentration of ink near the ejection nozzle 11 increases.

FIG. 5D illustrates the state immediately after the circulating flow 27 is generated again by the second energy generating element 24. As in the state of FIG. 5B, the concentration near the ejection nozzle 11 is eliminated, and the concentration is also eliminated throughout the individual flow passage 23.

Thus, in the straight-type ink circulation configuration in which the inflow port 37 and the outflow port 38 of the individual flow passage 23 are separated, the concentrated state is eliminated even when the temporary pauses and circulation operations are repeatedly performed.

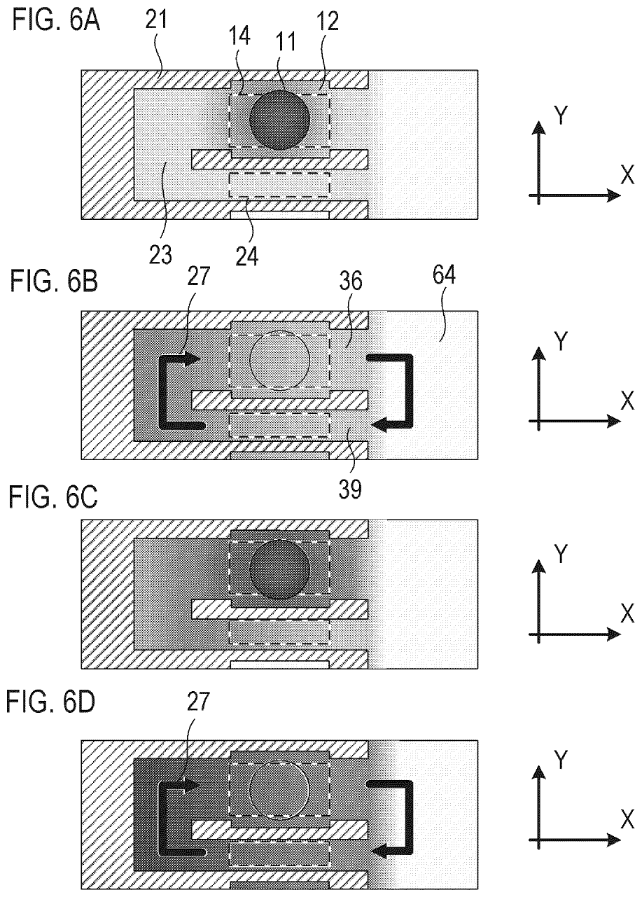

FIGS. 6A to 6D are diagrams illustrating the circulating flow and concentration of ink in the U-shaped ink circulation configuration of the comparative example.

FIG. 6A illustrates the state when the recording operation by the liquid ejection apparatus is temporarily paused. When the recording operation is temporarily paused, the concentration of ink near the ejection nozzle 11 increases.

FIG. 6B illustrates the state immediately after the circulating flow 27 is generated by the second energy generating element 24. In the U-shaped ink circulation configuration, the inflow port 39 and the outflow port 36 of the individual flow passage 23 are connected to the same flow passage 64 and are adjacent to each other. Therefore, although the concentrated ink near the ejection nozzle 11 is discharged from the outflow port 36 of the individual flow passage 23, it can flow back into the individual flow passage 23 from the inflow port 39. As a result, even when the circulating flow 27 is generated, the entire individual flow passage 23 is replaced not with fresh ink but with slightly concentrated ink. This phenomenon is referred to as re-circulation concentration.

FIG. 6C illustrates the state when the recording operation is temporarily paused again. From the state of FIG. 6B, the concentration of ink near the ejection nozzle 11 further increases.

FIG. 6D illustrates the state immediately after the circulating flow 27 is generated again by the second energy generating element 24. As described in FIG. 6B, due to the effect of re-circulation concentration, the entire individual flow passage 23 is filled with ink that is more concentrated than that in FIG. 6B.

Thus, in the U-shaped ink circulation configuration in which the inflow port 39 and outflow port 36 of the individual flow passage 23 are adjacent, when temporary pauses and circulation operations are repeatedly performed, the concentrated state is not alleviated, and concentration gradually increases throughout the entire individual flow passage 23. In addition, even without repeated circulation operations, if the concentration near the ejection nozzle 11 becomes large due to a long pause or similar conditions, it is difficult to improve the concentrated state even with the first circulation operation. This is because the effectiveness of improving the concentrated state is limited due to re-circulation concentration.

Therefore, there is a difference in how concentration is alleviated after temporary pauses and circulation operations between the straight-type where the inlet and outlet of the individual flow passage are separated, and the U-shaped type where the inlet and outlet of the individual flow passage are adjacent, due to differences in the discharge effects of concentrated ink. In the straight-type, the concentrated state is easily alleviated throughout the individual flow passage, thus reducing the likelihood of decreased ejection stability due to concentrated ink. On the other hand, in the U-shaped type, the concentrated state is difficult to resolve throughout the individual flow passage due to re-circulation concentration, causing ejection to become unstable as concentration increases throughout the individual flow passage.

### Ink

By generating an ink circulating flow in the individual flow passage 23 using an electrothermal transducer (circulation heater) as the second energy generating element 24, it is possible to suppress the influence of concentrated ink thickened due to evaporation of volatile components at the ejection nozzle 11. As a result, the ink ejection state can be maintained well, changes in ejection speed and the like can be reduced, and ejection can be stabilized.

Here, depending on the application of the liquid ejection head 1 or liquid ejection apparatus 50, the type of colorant in the ink used and the solid content may differ. For example, in plain paper, to suppress curling (warping) or cockling (wavy wrinkles) caused by water in the ink, ink with reduced moisture content is considered for use. In ink with low moisture content, the concentration of solids such as organic solvents other than water, pigments, and resins is high, so a rapid increase in viscosity easily occurs due to moisture evaporation, leading to a decrease in ink ejection stability. Generally, ink with a solid content of 10 wt % (mass %) or more can be regarded as ink with a high solid content.

In the liquid ejection head 1 of Example 1, since a circulating flow 27 can be generated in the individual flow passage 23 having the pressure chamber 12, even when ink containing 10 wt % (mass %) or more solid content is used, the increase in ink viscosity can be suppressed. Therefore, the present disclosure can be suitably applied to a liquid ejection head 1 and liquid ejection apparatus 50 using ink containing 10 wt % (mass %) or more solid content. According to the liquid ejection head 1 of Example 1, ejection stability can be maintained well regardless of the type of ink.

Regarding the operating temperature of the liquid ejection head 1, the entire chip may be heated to a constant temperature by arranging and controlling heaters. Since the viscosity of ink changes according to temperature, the ink viscosity at the head operating temperature affects ejection stability.

In the liquid ejection head 1 of Example 1, the flow velocity of the circulating flow 27 that can be formed in the individual flow passage 23 by driving the second energy generating element 24 is an instantaneous flow velocity of several tens of mm/s to 1000 mm/s. The average flow velocity over a time width on the order of several hundred microseconds depends on the driving frequency of the second energy generating element 24. This is because the circulating flow 27 generated by the second energy generating element 24 is a transient flow that attenuates over time and stops after a certain time. When the driving frequency of the second energy generating element 24 is about 10 to 20 kHz, which is approximately the same as the driving frequency (ejection frequency) of the first energy generating element 14, the average flow velocity of the circulating flow 27 that can be formed is several mm/s to 100 mm/s.

When ink with a high pigment concentration is used, ink thickening increases at the ejection nozzle 11 according to the non-ejection time (pause time), and ejection speed changes and ejection stability tends to decrease. For example, ink with a viscosity at the head operating temperature of at least 3 cP and not more than 6 cP can be regarded as ink with a high pigment concentration. When using such ink, ink circulation may be performed while the pause time is short. Therefore, steady ink circulation or high-frequency transient ink circulation may be performed to resolve concentration. In the liquid ejection head 1 of Example 1, transient ink circulation can be generated in the individual flow passage 23 by driving the second energy generating element 24. Therefore, in the liquid ejection head 1 of Example 1, by performing circulation operation at high frequency, concentration at the ejection nozzle 11 when using high-concentration ink can be alleviated.

When ink with a low pigment concentration is used, ejection speed changes may occur according to the non-ejection time (pause time), but the influence is relatively small compared to high-concentration ink. For example, ink with a viscosity at the head operating temperature of 1 cP or more and less than 3 cP can be regarded as ink with a low pigment concentration. When the pause time becomes long, ink thickening increases at the ejection nozzle 11 according to the non-printing drive time (stop time). When restarting after stopping without printing for a certain time, recovery operations such as suction, wiping, and preliminary ejection combined with these can suppress the influence of thickened ink, but these recovery operations involve waste ink.

In the liquid ejection head 1 of Example 1, by driving the second energy generating element 24 to form a circulating flow 27 in the individual flow passage 23, concentration at the ejection nozzle 11 can be alleviated and ink thickening can be suppressed. Therefore, depending on the stop time, it is possible to perform recovery processing by circulation operation alone without generating waste ink. In addition, by performing circulation operation for recovery while combining suction operation for removing bubbles inside the head separate from concentration resolution, recovery processing with reduced waste ink can be achieved.

Regardless of the ink concentration, to suppress the influence of concentrated ink, it is desirable to supply fresh ink near the ejection nozzle 11. When a circulation heater is used as the second energy generating element 24, the less re-circulation contributes to ink concentration, the more effective the ink circulation becomes. Compared with the U-shaped ink circulation configuration, the straight-type ink circulation configuration exhibits a greater effect in maintaining ejection performance through ink circulation.

### Drive Control

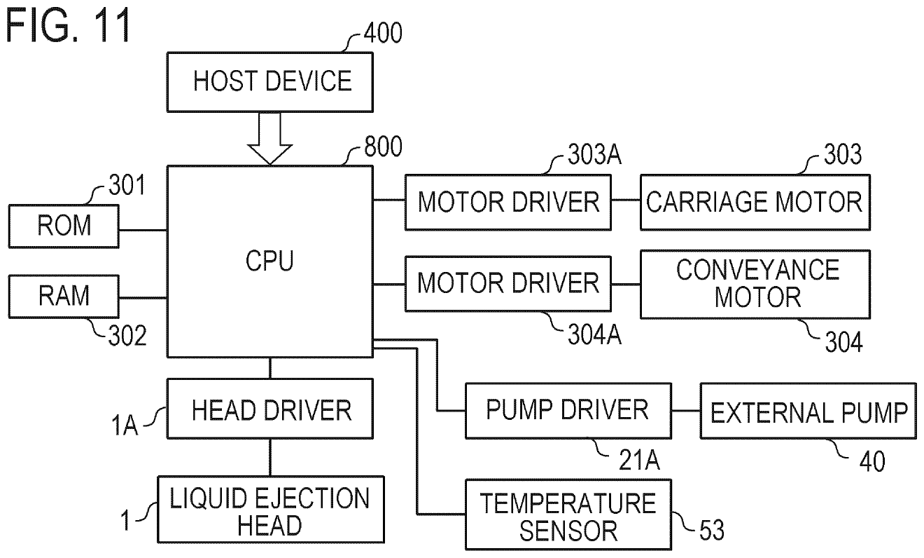

FIG. 11 is a block diagram illustrating the control configuration of the liquid ejection apparatus 50 in Example 1. A CPU 800 is a control portion that controls the operations of each part of the liquid ejection apparatus 50 based on programs such as processing procedures stored in a ROM 301. A RAM 302 is used as a work area or the like when the CPU 800 executes processing. The CPU 800 receives image data from a host device 400 outside the liquid ejection apparatus 50, and controls the liquid ejection head 1 by controlling the head driver 1A based on the image data. The CPU 800 receives temperature information detected from the temperature sensor 53. The CPU 800 controls the driving of the first energy generating element 14 and the second energy generating element 24 of the liquid ejection head 1 via the head driver 1A. In particular, the CPU 800 is a control unit for controlling the driving of the second energy generating element 24 based on the temperature detected by the temperature sensor 53.

The CPU 800 also controls the drivers of various actuators provided in the liquid ejection apparatus 50. For example, the CPU 800 controls the motor driver 303A for the carriage motor 303 that moves the carriage 60, the motor driver 304A for the conveyance motor 304 that conveys the recording medium P, and the pump driver 21A for the external pump 40. Note that FIGS. 2A to 2D illustrate a mode in which image data from the host device 400 is received and processed, but processing may be performed in the liquid ejection apparatus 50 without relying on data from the host device 400.

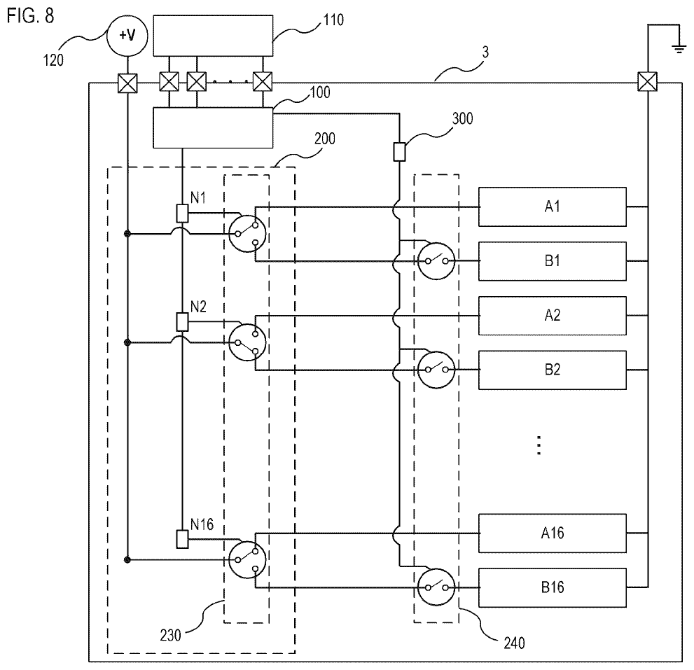

FIG. 8 is a diagram illustrating the control configuration of the liquid ejection head 1 in Example 1. On the substrate 18 of the liquid ejection chip 3, a controller 100, selection drive circuit 200, on-off drive circuit 240, first energy generating elements 14 (An) (n=1 to 16), and second energy generating elements 24 (Bn) (n=1 to 16) are provided. The liquid ejection chip 3 is connected to an external power supply 120 and an external circuit 110. The external circuit 110 includes the head driver 1A illustrated in FIG. 11. CPU 800, which controls the head driver 1A, is a control unit for controlling the driving of the first energy generating element 14 and the second energy generating element 24.

The selection drive circuit 200 includes an on-on drive circuit 230 for selecting the first energy generating element 14 and the second energy generating element 24. The on-on drive circuit 230 responds to control signals at each address Nn (n=1 to 16) received from the controller 100, and drives either the first energy generating element 14 or the second energy generating element 24 by turning it on. The controller 100 controls the drive pulses for driving the first energy generating element 14 or the second energy generating element 24, and the time intervals for applying those drive pulses to each element.

The controller 100 controls the on-off drive circuit 240 by means of a drive enable/disable signal 300 for the second energy generating element 24. Thus, when the second energy generating element 24 is selected in the on-on drive circuit 230, the driving of the second energy generating element 24 is controlled.

In this way, the on-on drive circuit 230 and the on-off drive circuit 240 control the driving of the second energy generating element 24.

If the drive enable/disable signal 300 is a signal not to drive the second energy generating element 24, then even when the second energy generating element 24 is selected in the on-on drive circuit 230, the second energy generating element 24 is not driven. In this case, neither the first energy generating element 14 nor the second energy generating element 24 is driven. On the other hand, if the first energy generating element 14 is selected in the on-on drive circuit 230, the first energy generating element 14 is driven.

If the drive enable/disable signal 300 is a signal to drive the second energy generating element 24, then if the second energy generating element 24 is selected in the on-on drive circuit 230, the second energy generating element 24 is driven. If the first energy generating element 14 is selected, the first energy generating element 14 is driven.

Therefore, the second energy generating element 24 is controlled according to the drive data for the first energy generating element 14 and the drive enable/disable signal 300. Accordingly, it is not necessary to provide drive data for the second energy generating element 24, and the amount of drive data can be reduced by half.

Note that, in the example of FIG. 8, a configuration is illustrated in which 16 pairs (a total of 32 elements) of the first energy generating element 14 and the second energy generating element 24 are controlled as one group, but the present invention is not limited thereto. For example, 8 pairs (16 elements) or 12 pairs (24 elements) of the first energy generating element 14 and the second energy generating element 24 may be controlled as one group. Even when there is a plurality of second energy generating elements 24, a common drive enable/disable signal 300 can be used.

FIGS. 9A to 9C are diagrams illustrating the liquid ejection head 1 of Example 1. FIG. 9A is a diagram illustrating the configuration near the ejection nozzle 11 of the liquid ejection head 1 of Example 1, and illustrates the main components when the liquid ejection head 1 is viewed in the Z direction. FIG. 9B is a cross-sectional view taken along line AA of FIG. 9A. FIG. 9C is a cross-sectional view taken along line AA of FIG. 9A, and is a cross-sectional view of a liquid ejection head 1 having a configuration different from that of FIG. 9B.

The liquid ejection head 1 of Example 1 has a first ejection nozzle array 63a composed of a plurality of ejection nozzles 11 arranged in the first direction (Y direction), and a second ejection nozzle array 63b provided side by side with the first ejection nozzle array 63a in the second direction (X direction) intersecting the first direction (Y direction).

The liquid ejection head 1 has a plurality of first individual flow passages 23a, each communicating with the plurality of ejection nozzles 11 of the first ejection nozzle array 63a and extending in the X direction, and a plurality of second individual flow passages 23b, each communicating with the plurality of ejection nozzles 11 of the second ejection nozzle array 63b and extending in the X direction.

At positions corresponding to the ejection nozzles 11 in the plurality of first individual flow passages 23a and the plurality of second individual flow passages 23b, first energy generating elements 14 for generating energy to eject liquid from the ejection nozzles 11 are provided. In the plurality of first individual flow passages 23a and the plurality of second individual flow passages 23b, second energy generating elements 24 for generating energy to cause the liquid to flow are provided side by side with the first energy generating elements 14 in the X direction.

On the side opposite to the second ejection nozzle array 63b across the first ejection nozzle array 63a in the X direction, a first flow passage 71 is provided, which communicates with one end 37a of the first individual flow passages 23a. Between the first ejection nozzle array 63a and the second ejection nozzle array 63b in the X direction, a second flow passage 72 is provided, which communicates with the other end 38a of the first individual flow passages 23a and one end 38b of the second individual flow passages 23b. On the side opposite to the first ejection nozzle array 63a across the second ejection nozzle array 63b in the X direction, a third flow passage 73 is provided, which communicates with the other end 37b of the second individual flow passages 23b.

The first flow passage 71 is provided with a plurality of first openings 22, arranged in the Y direction, through which liquid flows into or from the first flow passage 71. The second flow passage 72 is provided with a plurality of second openings 32, arranged in the Y direction, through which liquid flows into or from the second flow passage 72. The third flow passage 73 is provided with a plurality of third openings 42, arranged in the Y direction, through which liquid flows into or from the third flow passage 73.

The first energy generating element 14 provided in the first individual flow passage 23a and the first energy generating element 14 provided in the second individual flow passage 23b are both located near the second opening 32. In addition, the second energy generating element 24 provided in the first individual flow passage 23a is located near the first opening 22, and the second energy generating element 24 provided in the second individual flow passage 23b is located near the third opening 42.

In each of the first individual flow passages 23a, the second energy generating element 24 is provided at a position in the X direction closer to the first flow passage 71 than the first energy generating element 14. Therefore, the flow resistance R1 between the second energy generating element 24 and the end of the first individual flow passage 23a on the first flow passage 71 side is smaller than the flow resistance R2 between the second energy generating element 24 and the end of the first individual flow passage 23a on the second flow passage 72 side.

In each of the second individual flow passages 23b, the second energy generating element 24 is provided at a position in the X direction closer to the third flow passage 73 than the first energy generating element 14. Therefore, the flow resistance R1 between the second energy generating element 24 and the end of the second individual flow passage 23b on the third flow passage 73 side is smaller than the flow resistance R2 between the second energy generating element 24 and the end of the first individual flow passage 23a on the second flow passage 72 side.

Therefore, as described in the reference example, in each of the first individual flow passages 23a, the energy generated by the second energy generating element 24 causes liquid to flow from the first flow passage 71 toward the second flow passage 72. In addition, in each of the second individual flow passages 23b, the energy generated by the second energy generating element 24 causes liquid to flow from the third flow passage 73 toward the second flow passage 72. That is, the circulating flow 27 flows from the second energy generating element 24 toward the first energy generating element 14. Accordingly, a flow occurs in which liquid flows in from the first opening 22 and the third opening 42 and flows out through the second opening 32.

Let D1 denote the Y-direction size of the first non-opening part 81 between two adjacent first openings 22. Let D2 and D3 denote the Y-direction sizes of the second and third non-opening parts 82 and 83 between adjacent second and third openings 32 and 42, respectively. The liquid ejection head 1 of Example 1 is characterized in that D2>D1 and D2>D3. The first non-opening part 81 between two adjacent first openings 22 is the part between the closest Y-direction ends of adjacent first openings 22, and is the beam between the common flow passage 29 and the first flow passage 71 in the Z direction. The second non-opening part 82 and the third non-opening part 83 are similar. That is, a feature of Example 1 is that the beam between the second openings 32 is larger than the beams between the first openings 22 and the third openings 42.

In Example 1, the first openings 22, second openings 32, and third openings 42 are all substantially rectangular in shape, and the number of first openings 22 and third openings 42 per unit length in the Y direction is equal. The number of second openings 32 per unit length in the Y direction is less than the number of first openings 22 and third openings 42. For example, the second openings 32 are arranged at a 150 dpi pitch, and the first openings 22 and third openings 42 are arranged at a 300 dpi pitch. In this case, D1=D3.

A temperature sensor 53 is provided in the second non-opening part 82. In FIG. 9A, the temperature sensor 53 is provided in a plurality of second non-opening parts 82 at different positions in the Y direction, and as a whole, a plurality of temperature sensors 53 are provided. All of the second non-opening parts 82 may be provided with temperature sensors 53, only some of the second non-opening parts 82 may be provided with temperature sensors 53, or a temperature sensor 53 may be provided in only one place of the second non-opening part 82.

CPU 800 controls the driving of the second energy generating element 24 based on the temperature detected by the temperature sensor 53. In Example 1, a plurality of temperature sensors 53 is provided at different positions in the Y direction, and the CPU 800 controls the driving of the second energy generating element 24 at a position corresponding to the temperature sensor 53 based on the temperature detected by that temperature sensor 53. The second energy generating element 24 at a position corresponding to the temperature sensor 53 refers, for example, to the second energy generating element 24 located within a predetermined range in the +Y direction centered on the Y-direction position of the temperature sensor 53.

The effects of the liquid ejection head 1 of Example 1 will be described. In the liquid ejection head 1, a plurality of rows of second energy generating elements 24 arranged in the Y direction is provided. When the driving of these second energy generating elements 24 is ON/OFF controlled, a temperature distribution occurs in the liquid ejection chip 3 of the liquid ejection head 1. In the liquid ejection head 1 of Example 1, the temperature sensor 53 can detect the temperature distribution inside the liquid ejection chip 3. CPU 800 can adjust the number of times the second energy generating element 24 is driven according to this chip temperature distribution. For example, when the temperature is low, the number of times the second energy generating element 24 is driven is increased, and when the temperature is high, the number of times the second energy generating element 24 is driven is decreased. That is, the higher the temperature detected by the temperature sensor 53, the fewer the number of times the second energy generating element 24 is driven. The fewer the number of times the second energy generating element 24 is driven, the less the effect of heat generated by driving the second energy generating element 24, so the rise in chip temperature can be suppressed. Therefore, according to the liquid ejection head 1 of Example 1, an appropriate circulating flow 27 can be generated according to the temperature distribution inside the chip. Therefore, it is possible to eliminate ink concentration by circulating flow 27 generated by driving the second energy generating element 24, and to suppress temperature variation inside the liquid ejection chip 3 caused by heat generated by driving the second energy generating element 24.

Further, since the temperature sensor 53 is provided in the vicinity of the second energy generating element 24, the temperature distribution caused by the driving of the second energy generating element 24 can be detected with high accuracy. In addition, by making the Y-direction size D2 of the second non-opening part 82 larger than the sizes D1 and D3 of the first non-opening part 81 and the third non-opening part 83, an installation space for the temperature sensor 53 is provided between two rows of second energy generating elements 24 extending in the Y direction. As such, compared to the case in which temperature sensors 53 are provided independently for each row of second energy generating elements 24, the number of temperature sensors 53 to be installed can be reduced.

By driving the second energy generating element 24, a circulating flow 27 is generated, and ink concentration in the ejection nozzle 11 can be eliminated. To enhance the effect of the circulating flow 27, it is effective to increase the number of times the second energy generating element 24 is driven. However, unlike the driving of the first energy generating element 14, when the second energy generating element 24 is driven, ink ejection does not occur. As a result, the heat dissipation effect by ink ejection is small, and heat tends to accumulate in the liquid ejection chip 3, making it easier for the temperature of the liquid ejection chip 3 to rise. When the temperature inside the liquid ejection chip 3 rises, the evaporation rate from the ejection nozzle 11 increases, so ink concentration near the ejection nozzle 11 is likely to increase.

In this regard, in the liquid ejection head 1 of Example 1, as previously described, by controlling the driving of the second energy generating element 24 based on the temperature detected by the temperature sensor 53, temperature variation caused by heat generated by driving the second energy generating element 24 can be suppressed. Therefore, even when the number of times the second energy generating element 24 is driven is increased, ink concentration can be suppressed from increasing while suppressing temperature variation.

Further, the plurality of second energy generating elements 24 arranged for each ejection nozzle 11 can be individually controlled for ON/OFF driving, for example, according to the concentration level for each ejection nozzle 11. However, if the driving of the second energy generating element 24 is individually ON/OFF controlled, a temperature distribution may occur in the liquid ejection chip 3 due to the heat generated by driving the second energy generating element 24, and temperature variation may increase.

In this regard, in the liquid ejection head 1 of Example 1, as described above, by controlling the driving of the second energy generating element 24 based on the temperature detected by the temperature sensor 53, temperature variation caused by heat generated by driving the second energy generating element 24 can be suppressed.

With the recent increase in chip length due to improved productivity and the reduction in inter-row distance due to cost reduction, excessive temperature rise and temperature variation due to the above-mentioned heat effects are likely to appear in multi-color chips. By applying the liquid ejection head 1 of Example 1 to such multi-color chips, temperature variation due to heat effects can be suppressed advantageously.

The shape of the back side of the substrate 18 varies depending on the etching method used for the substrate 18. FIG. 9B illustrates a configuration in which a common flow passage 29 is formed in the substrate 18 by Si processing using anisotropic etching, and the first opening 22, second opening 32, and third opening 42 are formed by dry processing. FIG. 9C illustrates a configuration in which a common flow passage 29 is formed in the substrate 18 by Si processing using dry etching, and further the first opening 22, second opening 32, and third opening 42 are formed. The liquid ejection head 1 of Example 1 can achieve the above effects regardless of the shape of the substrate 18.

In addition, it is possible to provide wiring in the region (beam) between two adjacent first openings 22 and in the region (beam) between two adjacent third openings 42.

Note that, in the liquid ejection head 1 of Example 1, the Y-direction positions of the first opening 22 and the third opening 42 may be the same as illustrated in FIG. 9A, or may be different. For example, the Y-direction positions of the first opening 22 and the third opening 42 may be shifted according to the Y-direction positions of the ejection nozzles 11 in the first ejection nozzle array 63a and the second ejection nozzle array 63b. This also applies to embodiments other than Example 1.

### Example 2

FIGS. 10A and 10B are diagrams illustrating the liquid ejection head 1 of Example 2. FIG. 10A is a diagram illustrating the configuration near the ejection nozzle 11 of the liquid ejection head 1 of Example 2, and illustrates the main components when the liquid ejection head 1 is viewed in the Z direction. FIG. 10B is a cross-sectional view taken along line AA of FIG. 10A.

The difference between Example 2 and Example 1 is that the second energy generating element 24 provided in the first individual flow passage 23a and the second energy generating element 24 provided in the second individual flow passage 23b are both located near the second opening 32. In addition, the first energy generating element 14 provided in the first individual flow passage 23a is located near the first opening 22, and the first energy generating element 14 provided in the second individual flow passage 23b is located near the third opening 42.

In each of the first individual flow passages 23a, the second energy generating element 24 is provided at a position in the X direction closer to the second flow passage 72 than the first energy generating element 14. Therefore, the flow resistance R1 between the second energy generating element 24 and the end of the first individual flow passage 23a on the second flow passage 72 side is smaller than the flow resistance R2 between the second energy generating element 24 and the end of the first individual flow passage 23a on the first flow passage 71 side.

In each of the second individual flow passages 23b, the second energy generating element 24 is provided at a position in the X direction closer to the second flow passage 72 than the first energy generating element 14. Therefore, the flow resistance R1 between the second energy generating element 24 and the end of the second individual flow passage 23b on the second flow passage 72 side is smaller than the flow resistance R2 between the second energy generating element 24 and the end of the first individual flow passage 23a on the third flow passage 73 side.

Therefore, in each of the first individual flow passages 23a, the energy generated by the second energy generating element 24 causes liquid to flow from the second flow passage 72 side toward the first flow passage 71 side. In addition, in each of the second individual flow passages 23b, the energy generated by the second energy generating element 24 causes liquid to flow from the second flow passage 72 side toward the third flow passage 73 side. That is, the circulating flow 27 flows from the second energy generating element 24 toward the first energy generating element 14. As a result, a flow is generated that flows in from the second opening 32 and flows out to the first opening 22 and the third opening 42. The fact that D2>D1 and D2>D3 is the same as in Example 1.

The effects of the liquid ejection head 1 of Example 2 will be described. In Example 2, the second energy generating element 24 is positioned close to the second opening 32. Therefore, the temperature sensor 53 provided in the second non-opening part 82 is also positioned close to the second energy generating element 24. As a result, temperature changes due to heat generation by the second energy generating element 24 can be detected more accurately by the temperature sensor 53. This allows the temperature distribution within the chip to be detected more accurately, and the drive control of the second energy generating element 24 based on the temperature detected by the temperature sensor 53 can be performed more accurately. Therefore, temperature variation in the liquid ejection head 1 can be more reliably suppressed.

Furthermore, since the concentrated ink near the ejection nozzle 11 is discharged via branching into both the first flow passage 71 and the third flow passage 73, the influence of concentrated ink when it re-enters the individual flow passage during ejection or similar operations can be reduced.

According to the present disclosure, in a liquid ejection head provided with a first energy generating element for ejecting liquid and a second energy generating element for causing liquid to flow in an individual flow passage communicating with the ejection nozzle, excessive temperature rise can be suppressed.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-156847, filed on Sep. 10, 2024, which is hereby incorporated by reference herein in its entirety.

What is claimed is:

1. A liquid ejection head having an ejection nozzle for ejecting liquid, comprising:
a first ejection nozzle array composed of a plurality of ejection nozzles arranged in a first direction;
a second ejection nozzle array composed of a plurality of ejection nozzles arranged in the first direction, the second ejection nozzle array being provided side by side with the first ejection nozzle array in a second direction intersecting the first direction;
a plurality of first individual flow passages communicating respectively with the plurality of ejection nozzles of the first ejection nozzle array, the plurality of first individual flow passages extending in the second direction;
a plurality of second individual flow passages communicating respectively with the plurality of ejection nozzles of the second ejection nozzle array, the plurality of second individual flow passages extending in the second direction;
first energy generating elements provided at positions corresponding to the ejection nozzles in the plurality of first individual flow passages and the plurality of second individual flow passages, the first energy generating elements generating energy for ejecting liquid from the ejection nozzles;
second energy generating elements provided side by side with the first energy generating elements in the second direction in the plurality of first individual flow passages and the plurality of second individual flow passages, the second energy generating elements generating energy for causing the liquid to flow;
a first flow passage provided on the opposite side to the second ejection nozzle array across the first ejection nozzle array in the second direction, the first flow passage communicating with ends on one side of the plurality of first individual flow passages;
a second flow passage provided between the first ejection nozzle array and the second ejection nozzle array in the second direction, the second flow passage communicating with ends on the other side of the plurality of first individual flow passages and ends on one side of the plurality of second individual flow passages;
a third flow passage provided on the opposite side to the first ejection nozzle array across the second ejection nozzle array in the second direction, the third flow passage communicating with ends on the other side of the plurality of second individual flow passages;
a plurality of first openings arranged in the first direction provided in the first flow passage, the first openings allowing liquid to flow into or from the first flow passage;
a plurality of second openings arranged in the first direction provided in the second flow passage, the second openings allowing liquid to flow into or from the second flow passage; and
a plurality of third openings arranged in the first direction provided in the third flow passage, the third openings allowing liquid to flow into or from the third flow passage, wherein, in a case where
D1 is a size in the first direction of a first non-opening part between two adjacent first openings,
D2 is a size in the first direction of a second non-opening part between two adjacent second openings, and
D3 is a size in the first direction of a third non-opening part between two adjacent third openings, then
D2>D1, and
D2>D3,
and, wherein
the liquid ejection head further comprises:
a temperature sensor provided in the second non-opening part; and
a control unit for controlling driving of the second energy generating element based on the temperature detected by the temperature sensor.

2. The liquid ejection head according to claim 1,
wherein the temperature sensor is provided in a plurality of the second non-opening parts at different positions in the first direction, and
wherein the control unit controls the driving of the second energy generating element at a position corresponding to the second non-opening part where the temperature sensor is provided, based on the temperature detected by the temperature sensor.

3. The liquid ejection head according to claim 1,
wherein the control unit reduces the number of times the second energy generating element is driven as the temperature detected by the temperature sensor increases.

4. The liquid ejection head according to claim 1,
wherein D1=D3.

5. The liquid ejection head according to claim 1,
wherein the number of the second openings per unit length in the first direction is less than the number of the first openings per unit length in the first direction and less than the number of the third openings per unit length in the first direction.

6. The liquid ejection head according to claim 1,
wherein, in each of the plurality of first individual flow passages, the second energy generating element is provided at a position in the second direction closer to the first flow passage than the first energy generating element,
wherein, in each of the plurality of first individual flow passages, the flow resistance R1 between the second energy generating element and the end of the first individual flow passage closer to the first flow passage is smaller than the flow resistance R2 between the second energy generating element and the end of the first individual flow passage closer to the second flow passage,
wherein, in each of the plurality of second individual flow passages, the second energy generating element is provided at a position in the second direction closer to the third flow passage than the first energy generating element,
wherein, in each of the plurality of second individual flow passages, the flow resistance R1 between the second energy generating element and the end of the second individual flow passage closer to the third flow passage is smaller than the flow resistance R2 between the second energy generating element and the end of the second individual flow passage closer to the second flow passage,
wherein, in each of the plurality of first individual flow passages, the energy generated by the second energy generating element causes liquid to flow from the end closer to the first flow passage toward the end closer to the second flow passage, and
wherein, in each of the plurality of second individual flow passages, the energy generated by the second energy generating element causes liquid to flow from the end closer to the third flow passage toward the end closer to the second flow passage.

7. The liquid ejection head according to claim 1,
wherein, in each of the plurality of first individual flow passages, the second energy generating element is provided at a position in the second direction closer to the second flow passage than the first energy generating element,
wherein, in each of the plurality of first individual flow passages, the flow resistance R1 between the second energy generating element and the end of the first individual flow passage closer to the second flow passage is smaller than the flow resistance R2 between the second energy generating element and the end of the first individual flow passage closer to the first flow passage,
wherein, in each of the plurality of second individual flow passages, the second energy generating element is provided at a position in the second direction closer to the second flow passage than the first energy generating element,
wherein, in each of the plurality of second individual flow passages, the flow resistance R1 between the second energy generating element and the end of the second individual flow passage closer to the second flow passage is smaller than the flow resistance R2 between the second energy generating element and the end of the second individual flow passage closer to the third flow passage,
wherein, in each of the plurality of first individual flow passages, the energy generated by the second energy generating element causes liquid to flow from the end closer to the second flow passage toward the end closer to the first flow passage, and
wherein, in each of the plurality of second individual flow passages, the energy generated by the second energy generating element causes liquid to flow from the end closer to the second flow passage toward the end closer to the third flow passage.

8. The liquid ejection head according to claim 1,
wherein the second energy generating element is an electrothermal transducer.

9. The liquid ejection head according to claim 6,
wherein the second energy generating element is an electrothermal transducer, and a ratio R1/R2 of the flow resistances R1 and R2 is a value from 0.05 to 0.40.

10. The liquid ejection head according to claim 1,
wherein the first energy generating element is an electrothermal transducer.

11. The liquid ejection head according to claim 1,
wherein the control unit controls the driving of a plurality of the second energy generating elements using a common control signal.

12. A liquid ejection apparatus comprising:
the liquid ejection head according to claim 1; and
a supply unit for supplying liquid to the liquid ejection head.
